(19) United States
(12) Patent Application Publication
(10) Pub. No.: US 2015/0282244 A1
(43) Pub. Date: Oct. 1, 2015

(54) MOBILE DEVICE AND METHOD FOR MANAGING NETWORK CONNECTION AND STORAGE MEDIUM

(71) Applicant: HTC Corporation, Taoyuan County (TW)

(72) Inventors: Chien-Nan Lin, Taoyuan County (TW); Chen-Huang Fan, Taoyuan County (TW); Yu-Chuan Lai, Taoyuan County (TW)

(73) Assignee: HTC Corporation, Taoyuan County (TW)

(21) Appl. No.: 14/226,790

(22) Filed: Mar. 26, 2014

(51) Int. Cl. H04W 76/04; H04L 29/08; H04W 52/02

(52) U.S. Cl. CPC H04W 76/045; H04W 52/0229; H04W 52/0254; H04L 67/142

(57) ABSTRACT

A mobile device is provided. The mobile device includes a modem and a processor. The modem establishes a network connection to a wireless communication network. The processor is coupled to the modem. The processor executes an application and determines a period of sleep time associated with the mobile device.

The processor notifies the application that the network connection is deactivated during the sleep time and notifies the application that the network connection is activated outside the sleep time. However, the modem still maintains the network connection without deactivating the network connection during the sleep time.

### BACKGROUND OF THE INVENTION

1. Field of the Invention

The present invention relates to a mobile device, a method, and a storage medium for managing network connection of the mobile device. More particularly, the present invention relates to a mobile device, a method, and a storage medium for managing network connection of the mobile device during a period of sleep time associated with the mobile device.

2. Description of the Related Art

A modern mobile device can execute an operating system (OS) and multiple applications. Many applications are designed to provide services via Internet, such as instant message, email, calendar, contacts, stock market information and weather information, etc. These applications need a lot of information exchange with related servers in Internet.

However, these applications synchronize data and status with related servers in background even when the user does not need the services, which wakes the system up frequently and consumes much power.

### SUMMARY OF THE INVENTION

Accordingly, the present invention is directed to a mobile device, a method, and a storage medium for managing network connection of the mobile device. The mobile device, the method, and the computer program stored in the storage medium can block synchronization of data and status started by the applications during the sleep time associated with the mobile device to save power for the mobile device.

According to an embodiment of the present invention, a mobile device is provided. The mobile device includes a modem and a processor. The modem establishes a network connection to a wireless communication network. The processor is coupled to the modem. The processor executes an application and determines a period of sleep time associated with the mobile device. The processor notifies the application that the network connection is deactivated during the sleep time and notifies the application that the network connection is activated outside the sleep time. However, the modem still maintains the network connection without deactivating the network connection during the sleep time.

According to another embodiment of the present invention, a method for managing network connection of a mobile device is provided. The method includes the steps of determining a period of sleep time associated with the mobile device, establishing a network connection to a wireless communication network, notifying an application executed by the mobile device that the network connection is deactivated during the sleep time, notifying the application that the network connection is activated outside the sleep time, and maintaining the network connection without deactivating the network connection during the sleep time.

According to another embodiment of the present invention, a non-transient storage medium storing a computer program is provided. The computer program controls a mobile device to execute the aforementioned method when the mobile device loads and executes the computer program.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a mobile device according to an embodiment of the present invention.

FIG. 2 is a schematic diagram showing architecture of hardware and software of a mobile device according to an embodiment of the present invention.

FIG. 3 is a flow chart showing a method for managing network connection of a mobile device according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

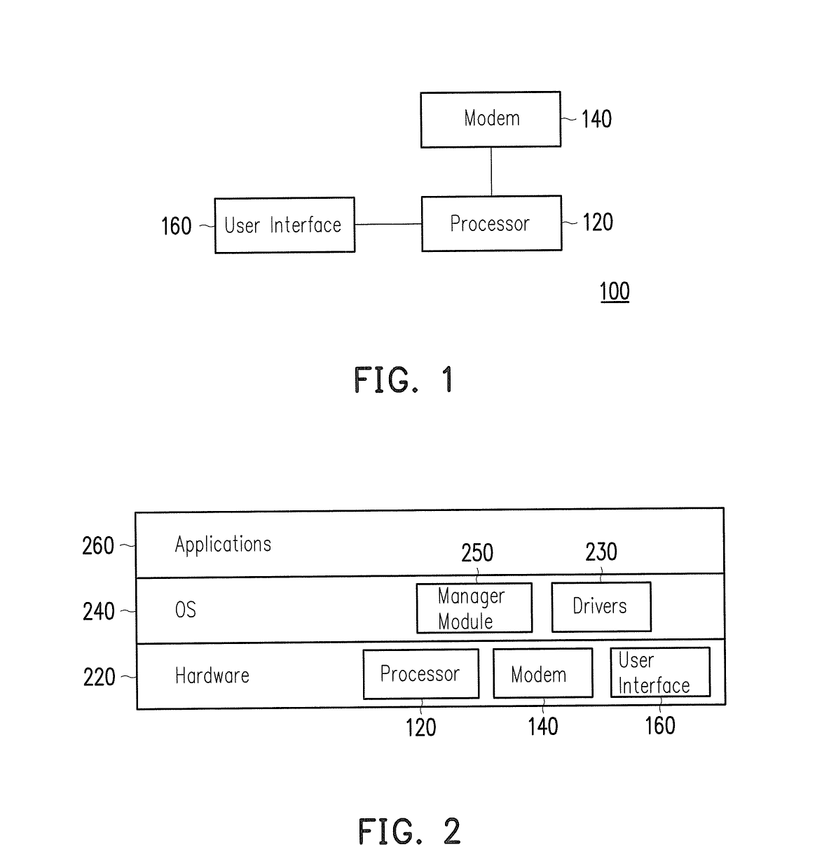

FIG. 1 is a schematic diagram showing a mobile device 100 according to an embodiment of the present invention. The mobile device 100 may be any portable electronic device capable of network access such as smart phone, personal digital assistant (PDA), tablet computer or notebook computer. The mobile device 100 includes a processor 120, a modem 140 and a user interface 160, which are hardware components of the mobile device 100. The processor 120 is coupled to the modem 140 and the user interface 160. The processor 120 executes an OS and one or more applications. The modem 140 is the communication interface between the mobile device 100 and the wireless communication network accessed by the mobile device 100. The user interface 160 receives input from the user and transmits graphical and/or acoustical output to the user.

For example, the user interface 160 may include one or more keys or buttons for receiving input from the user. The user interface 160 may include a touch pad for receiving input from the user. The user interface 160 may include a display for displaying graphical output to the user. The user interface 160 may include a touch display for receiving input from the user and displaying graphical output to the user. The user interface 160 may include a microphone for receiving acoustical input from the user and a speaker for transmitting acoustical output to the user.

FIG. 2 is a schematic diagram showing architecture of hardware and software of the mobile device 100 according to an embodiment of the present invention. The architecture includes three layers, namely, a hardware layer 220, an OS layer 240 based on the hardware layer 220, and an applications layer 260 based on the OS layer 240.

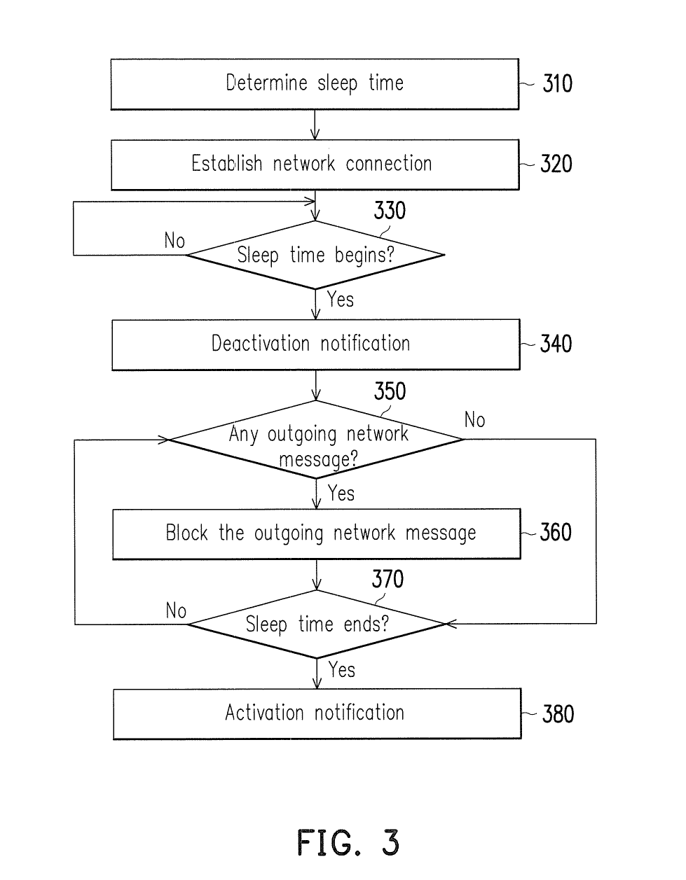

The hardware layer 220 includes the hardware components of the mobile device 100, such as the processor 120, the modem 140 and the user interface 160. The OS layer 240 is the OS executed by the mobile device 100. The OS layer 240 includes manager module 250 and drivers 230. The drivers 230 drive the modem 140 and the user interface 160. The manager module 250 is the main software component executing the method flow shown in FIG. 3. All steps in FIG. 3 are executed by the manager module 250 unless otherwise stated. The applications layer 260 includes all of the applications installed in the mobile device 100. The processor 120 executes the OS layer 240 and the applications layer 260, including the drivers 230 and the manager module 250. All applications mentioned below belong to the applications layer 260.

FIG. 3 is a flow chart showing a method for managing network connection of the mobile device 100 during a period of sleep time associated with the mobile device 100 according to an embodiment of the present invention. In brief, the sleep time is the time when the user of the mobile device 100 sleeps. The sleep time may be determined by a learning mechanism. Since the user does not need network services when he or she sleeps, the mobile device 100 can block network messages sent by applications during the sleep time to reduce power consumption and network usage.

In step 310, determine the sleep time of the mobile device 100. The sleep time may be determined according to the location of the mobile device 100, the network status of the mobile device 100, the activity status of the user interface 160 or any combination of above. The location of the mobile device 100 may be, but not limited to, identified according to the identification (ID) of the current network cell where the mobile device 100 is located or global positioning system (GPS) location information. The network status may be, but not limited to, whether the mobile device 100 is accessing a network (such as the Internet) or not, whether the mobile device 100 is roaming or not, the level of network signal strength, and so on. The activity status may be, but not limited to, whether the user interface 160 is active or inactive, whether user is operating on the user interface 160, and so on. For example, the user interface 160 may be regarded as inactive when the user interface 160 is not receiving any input and is not transmitting or displaying any output. When the user interface 160 includes a display and the screen of the display is turned off, the user interface 160 may be regarded as not displaying the output.

The mobile device 100 may be regarded as being idle when the mobile device 100 is not accessing any network and is not roaming and the user interface 160 is inactive. When the mobile device 100 is always idle at the same location in substantially the same period of time for a predetermined number of days, the manager module 250 may determine that period of time to be the sleep time of the mobile device 100.

In step 320, the modem 140 establishes a network connection to a wireless communication network for one or more applications to synchronize data and/or status with one or more related servers. In another example, step 320 may take place before step 310. The wireless communication network may be based on WiFi, Worldwide Interoperability for Microwave Access (WiMAX), 3G, 4G, general packet radio service (GPRS), Long Term Evolution (LTE), or any other similar standard. The network connection may have different names in different standards. For example, the network connection is known as packet data protocol context (PDP context) in GPRS and known as evolved packet system bearer (EPS bearer) in LTE.

In step 330, check whether the sleep time begins or not. Repeat step 330 when the sleep time does not begin yet. Notifying the applications that the network connection is deactivated in step 340 when the sleep time begins. The notification is notifying the applications that the current status of the network connection in the OS 240 is logically deactivated because the modem 140 still maintains the network connection during the sleep time without physically deactivating the network connection. The purpose of the notification is preventing the applications from sending outgoing network messages through the network connection and the wireless communication network during the sleep time without physically deactivating the network connection. Therefore, the network connection still exists between the mobile device 100 and the base station of the wireless communication network.

Although the applications are notified of the deactivation of the network connection in step 340, there is some chance that an application may still try to send outgoing network messages through the network connection during the sleep time. It is preferable to block these network messages until the sleep time ends. Therefore, check whether there is any application attempting to send an outgoing network message through the network connection during the sleep time in step 350. The flow skips step 360 and proceeds to step 370 when there is no such an application. The flow proceeds to step 360 when there is such an application.

In step 360, the manager module 250 blocks the outgoing network message sent by the aforementioned application. When the manager module 250 blocks the initial attempt of the application to send the outgoing network message during the sleep time, the application may retry later. The manager module 250 also blocks the later retries of the application to send the outgoing network message during the sleep time. The manager module 250 may block the attempts of the application by queuing the outgoing network messages or queuing the requests for sending the outgoing network messages until the sleep time ends. The outgoing network messages will be transmitted normally after the sleep time ends. Alternatively, the manager module 250 may simply discard the outgoing network messages or the corresponding requests during the sleep time. When the manager module 250 blocks the initial attempt of the application to send the outgoing network message during the sleep time, the application or the OS may start a timer to remind the application to retry later. In this case, the manager module 250 may suspend the timer until the sleep time ends.

When the user interface 160 receives input from the user or when the user turns on the screen of a display of the user interface 160, the manager module 250 may end the sleep time immediately so that the blocked outgoing network messages may be transmitted. In this case, the outgoing network messages are only postponed until the user needs them.

The manager module 250 blocks all outgoing network messages during the sleep time. On the other hand, the manager module 250 does not block any network message outside the sleep time. Whenever an application attempts to send an outgoing network message through the network connection outside the sleep time, the manager module 250 always allows the attempt.

In step 370, check whether the sleep time ends or not. The flow returns to step 350 when the sleep time is not over yet. Notify the applications that the network connection is activated in step 380 when the sleep time ends. This notification notifies the applications that the current status of the network connection in the OS 240 is logically activated because in fact the network connection was not physically deactivated previously. The modem 140 still maintains the network connection without deactivating or reactivating the network connection during the sleep time.

The purpose of the notifications sent to the applications in steps 340 and 380 is forging a disconnected network status to prevent the applications from sending outgoing network messages during the sleep time. In fact, the network connection is stilled maintained between the mobile device 100 and the base station of the wireless communication network. This mechanism of logical disconnection instead of physical disconnection can reduce power consumption of the mobile device 100 and reduce traffic load of the wireless communication network and the related servers. In addition, this mechanism shortens the response time of resuming the network connection because the network connection does not have to be physically recovered from previous deactivation.

The manager module 250 may send broadcast messages to notify the applications in steps 340 and 380, which means the manager module 250 may send a broadcast message to notify all of the applications that the network connection is deactivated in step 340 and the manager module 250 may send another broadcast message to notify all of the applications that the network connection is activated in step 380.

Alternatively, the manager module 250 may send dedicated messages to notify the applications in steps 340 and 380, which means the manager module 250 may send a dedicated message to each application to notify that the network connection is deactivated in step 340 Each application receives its own dedicated message from the manager module 250. Similarly, the manager module 250 may send another dedicated message to each application to notify that the network connection is activated in step 380. In another embodiment, the manager module 250 may send the aforementioned dedicated message exclusively to a group of applications which had previously register to the manager module 250 for receiving the dedicate message, so only the group of applications would receive the notification in step 340 and step 380.

Alternatively, the manager module 250 may record the state of the network connection. In this case, the manager module 250 updates the state of the network connection to be deactivated when the sleep time begins and updates the state of the network connection to be activated when the sleep time ends. Each application may poll the state of the network connection at any time. In response, the manager module 250 notifies the polling application of the deactivated state during the sleep time and notifies the polling application of the activated state outside the sleep time.

As recited above, the manager module 250 blocks all outgoing network messages during the sleep time. On the other hand, the manager module 250 does not block incoming network messages during the sleep time. When the modem 140 receives an incoming network message for an application through the network connection, the processor 120 forwards the incoming network message to the application no matter whether the mobile device 100 is in the sleep time or not. In this way, the network services associated with the applications, such as voice over Internet

Protocol (VoIP), instant message service (IMS), social network messages, weather information, and stock market information, can be always available.

In another embodiment of the present invention, a non-transient storage medium may store a computer program. The non-transient storage medium may be a non-volatile memory, a hard disk or an optical disc. The computer program may control the mobile device 100 to execute the method whose flow is shown in FIG. 3 when the mobile device 100 loads and executes the computer program.

In summary, the mobile device, the method, and the storage medium provided by the present invention can reduce power consumption of the mobile device and reduce traffic load of the wireless communication network and the related servers by blocking outgoing network traffic during the sleep time. The network services are still online because incoming network traffic is not blocked. The mobile device, the method, and the storage medium do not affect user experience, especially for applications that require always-on Internet services. After the sleep time, the network connection can be recovered for the applications very fast because the network connection is not physically deactivated in the sleep time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mobile device, comprising:
a modem, establishing a network connection to a wireless communication network; and
a processor, coupled to the modem, executing an application and determining a sleep time associated with the mobile device, notifying the application that the network connection is deactivated during the sleep time and notifying the application that the network connection is activated outside the sleep time, wherein the modem still maintains the network connection without deactivating the network connection during the sleep time.

2. The mobile device of claim 1, wherein the mobile device further comprises:
a user interface, coupled to the processor, receiving input and transmitting graphical and/or acoustical output, wherein the processor determines the sleep time according to at least one of a location of the mobile device, a network status of the mobile device, and an activity status of the user interface.

3. The mobile device of claim 1, wherein the processor sends a broadcast message to notify the application that the network connection is activated or deactivated.

4. The mobile device of claim 1, wherein the processor sends a dedicated message to notify the application that the network connection is activated or deactivated.

5. The mobile device of claim 4, wherein the application belongs to a group of applications previously registered to a manager module executed by the processor and only the group of applications receive the dedicated message.

6. The mobile device of claim 1, wherein the processor records a state of the network connection, the processor updates the state to be deactivated when the sleep time begins and updates the state to be activated when the sleep time ends, and the processor notifies the application of the state when the application polls the state.

7. The mobile device of claim 1, wherein whenever the application attempts to send an outgoing network message through the network connection during the sleep time, the processor blocks the attempt, and wherein whenever the application attempts to send the outgoing network message through the network connection outside the sleep time, the processor allows the attempt.

8. The mobile device of claim 7, wherein the processor blocks an initial attempt of the application to send the outgoing network message and blocks later retries of the application to send the outgoing network message during the sleep time.

9. The mobile device of claim 1, wherein when the modem receives an incoming network message for the application through the network connection, the processor forwards the incoming network message to the application no matter whether the mobile device is in the sleep time or not.

10. A method for managing network connection of a mobile device, comprising:
determining a sleep time associated with the mobile device;
establishing a network connection to a wireless communication network;
notifying an application executed by the mobile device that the network connection is deactivated during the sleep time;
notifying the application that the network connection is activated outside the sleep time; and
maintaining the network connection without deactivating the network connection during the sleep time.

11. The method of claim 10, wherein the step of determining the sleep time comprises:
determining the sleep time according to at least one of a location of the mobile device, a network status of the mobile device, and an activity status of a user interface of the mobile device.

12. The method of claim 10, wherein the steps of notifying the application comprise:
sending a broadcast message to notify the application that the network connection is activated or deactivated.

13. The method of claim 10, wherein the steps of notifying the application comprise:
sending a dedicated message to notify the application that the network connection is activated or deactivated.

14. The method of claim 13, wherein the application belongs to a group of applications previously registered to a manager module executed by the mobile device and only the group of applications receive the dedicated message.

15. The method of claim 10, wherein the steps of notifying the application comprise:
recording a state of the network connection;
updating the state to be deactivated when the sleep time begins;
updating the state to be activated when the sleep time ends; and
notifying the application of the state when the application polls the state.

16. The method of claim 10, further comprising:
whenever the application attempts to send an outgoing network message through the network connection during the sleep time, blocking the attempt; and
whenever the application attempts to send the outgoing network message through the network connection outside the sleep time, allowing the attempt.

17. The method of claim 16, further comprising:
blocking an initial attempt of the application to send the outgoing network message during the sleep time; and
blocking later retries of the application to send the outgoing network message during the sleep time.

18. The method of claim 10, further comprising:
when the mobile device receives an incoming network message for the application through the network connection, forwarding the incoming network message to the application no matter whether the mobile device is in the sleep time or not.

19. A non-transient storage medium storing a computer program, wherein the computer program controls a mobile device to execute the method of claim 10 when the mobile device loads and executes the computer program.
